(19) United States
(12) Patent Application Publication
(10) Pub. No.: US 2014/0262620 A1
(43) Pub. Date: Sep. 18, 2014

(54) LADDER TYPE TREE STAND

(71) Applicant: Robert J. Musco, Garden City, NY (US)

(72) Inventor: Robert J. Musco, Garden City, NY (US)

(21) Appl. No.: 13/827,375

(22) Filed: Mar. 14, 2013

(51) Int. Cl. A01M 31/02

(52) U.S. Cl. CPC A01M 31/02
USPC 182/116

(57) ABSTRACT

The present application is directed towards tree stand systems. The system includes a ladder section and a stand section.

### FIELD OF THE DISCLOSURE

The disclosure relates generally to the field of tree stands. More specifically, the present disclosure is directed to a tree stand that is portable, ladder type, and telescoping.

### BACKGROUND OF THE DISCLOSURE

Typical ladder type tree stands are heavy, weighing about 75-150 pounds, with each section being approximately five feel in length, or more, and typically are not transportable over great distances.—Due to the weight, and cumbersome nature of the stand, a user typically has to make multiple trips to transport the stand components to the location or struggle during one trip to carry a heavy and cumbersome device. Generally, once set-up they are not moved.

Once the user arrives at the location, it typically requires two to three people to set the stand up by tilting the ladder stand towards the tree and securing the stand to the tree with one or more safety straps.

What is desired is a tree stand that is portable, light weight, mobile, and can be effectively set up and removed by one person.

Embodiments of the present application provide a system that addresses the above and other issues.

### SUMMARY OF THE DISCLOSURE

The present application is directed towards ladder type tree stand systems. The system includes a ladder section and a stand section.

### BRIEF DESCRIPTION OF THE DRAWINGS

The present disclosure will be better understood by reference to the following drawings of which:

FIG. 1 is a general view of the tree stand system without detail;

FIG. 2 is a detailed view of the ladder section;

FIG. 3 a detailed view of the stand section;

FIG. 4 is a view of the tree stand system in a collapsed state; and

FIG. 5 is a detailed view of a partially extended tree stand system set up for use.

### DETAILED DESCRIPTION

The present application is directed towards a tree stand system 1, as illustrated in FIG. 1, which is a general view without detail. Tree stand system 1 includes two main components, ladder section 2 and stand section 3.

In FIG. 1, ladder section 2 can be seen in its fully extended state. Ladder section 2 in FIG. 2 is shown partially extended and is capable of fully extending (telescoping) to appear like the ladder section in FIG. 1. Ladder section 2 is shown in a more detailed view in FIG. 2, without stand section 3.

For use of the tree stand system 1, both the ladder section 2 and the stand section 3 can be guided into their extended positions, as shown in FIG. 1. In this position, ladder section 2 is extended to its full height and stand section is in position to accept a human's weight.

As can be seen in FIG. 2, ladder section 2 includes a base section 7, a mounting portion 10, a plurality of telescoping rail sections 4 and a plurality of locking mechanisms 6. Mounting portion 10 pivotally connects ladder section 2 to stand section 3 and is further described below.

Base section 7 contacts the ground and may include materials to avoid slipping of the base section 7 against the ground. Each of the rail sections 4 has left and right side rail members 8 and 8′, respectively, and a step unit 5. Step unit 5 passes horizontally between the left and right side rail members 8 and 8′ of each rail section 4 and is of suitable strength to support an adult human.

The left and right side rail members 8 and 8′ are tubular and can have any suitable cross-section shape including circular or a rectangular cross-section. The left and right side rail members 8 and 8′ of each rail member 4 have a sufficient internal diameter or cross-sectional area to accept the external diameter or cross-sectional area of the left and right side rail members 8 and 8′ of the rail section vertically above.

Each of the rail sections 4 also includes a locking mechanism 6. Locking mechanism 6 can include a biased button and hole so that the button can pass through the hole to keep the rail section 4 in an extended state. This non-limiting example of locking mechanism 6 does not include all possible mechanisms, and locking mechanism 6 can include any known mechanism to maintain a rail section in an extended state.

Once engaged, locking mechanism 6 causes each rail section to maintain an extended state, as seen in the bottom three rail sections 4 in FIG. 2. Once the locking mechanism 6 is disengaged, each rail section 4 slides into the rail section 4 vertically below it, as seen in the top eight rail sections 4 in FIG. 2. FIG. 2 illustrates one embodiment of ladder section 2, other embodiments can include fewer rail sections or more rail sections.

Ladder section 2 can also include a ladder strap 15. As shown in FIG. 2, the ladder strap 15 is attached to the second rail section 4, but ladder strap 15 can be connected to ladder section 2 at any one of the plurality of rail sections 4 and can be either fixed in one location or be capable of being moved to different rail sections. Since ladder strap 15 can be connected to any of the plurality of rail sections 4, ladder section 2 can support stand section 3 at many different heights above the ground. During set up of ladder section 2, one end of ladder strap 15 is fixed to a rail section 4 while the other end is extended around a tree or pole and then is secured to the rail section 4 using any suitable connection, such as a ratcheting connection. Ladder strap 15 can be made of any suitable material, such as a woven nylon or a hard plastic.

The fully collapsed length of the ladder section 2 is about two feet, with the fully extended length being about 15 feet or higher. Depending on how high stand section 3 is to be placed, a user can extend a few rail sections or all rail sections so that stand section can be between a few feet to about 15 feet or more off of the ground. For example, a user can extend half of the rail sections so that stand section 3 can be at about 50% of maximum height from the ground (with maximum height referring to extension of all rail sections). Other percentages of maximum height may be used depending on extension of varying amounts of rail sections.

Stand section 3, is shown in a more detailed view in FIG. 3. Stand section 3 can be permanently attached to ladder section 2 or stand section 3 can be removable from ladder section 2. For exemplary purposes, stand section 3 is shown as it would be when in use, with only a portion of ladder section 2 shown. Stand section 3 includes several components, including a platform 32, a seat section 34, supports 36 and a seat strap 38. Platform 32 can be any suitable size, approximately three feet in length by about two feet in width, and can be formed of any material that has the strength to support an adult human standing on it. Examples of material the platform can be composed of include, but are not limited to, a metal sheet and a metal mesh. In FIG. 3, a metal mesh is shown.

Platform 32 can also include one or more platform braces. As shown in FIG. 3, two platform braces 33 provide further support to platform 32. Platform 32 can be surrounded by platform frame 35, which provides further support to platform 32 and provides an area for connection to the ladder section 2.

Stand section 3 can also include braces 40 that support the platform 32 and the stand section 3 itself by connecting ladder section 2 to platform 32. Optionally, braces 40 can fold along a hinge 42 for storage or in preparation of moving the tree stand system 1.

Supports 36 extend from platform 32 to seat section 34. One end of supports 36 is pivotally connected to the platform 32 or platform frame 35, while the other end of supports 36 is pivotally connected to seat section 34. For explanation purposes, if the supports of FIG. 3 are along the y-axis, pivot connections allow for the seat section 34 to rotate about the x-axis and for the supports to rotate about the x-axis and lay against the platform 32. Although two supports 36 are shown in FIG. 3, one support can be included or three or more supports may be included.

Seat section 34 is of a sufficient size to provide support for an adult human to sit and can include padding surrounding an underlying structure.

Seat strap 38 is connected at both ends to supports 36 and extends around a tree section to secure tree stand system 1 to a tree 30 or pole. One end of seat strap 38 is secured to seat supports 36 while the other end is extended around tree 30 and is then secured to seat supports 36 using any suitable connection, such as a ratcheting connection. Seat strap 38 can be made of any suitable material, such as a woven nylon or a hard plastic.

Mounting portion 10 of ladder section 2 pivotally connects the platform frame 35 of ladder section 2 to stand section 3, forming a pivot connection 44. Pivot connection 44 can be one of several connections that allow for ladder portion 2 to pivot or rotate around the axis formed by the mounting portion 10. For example, pivot connection 44 allows ladder section 2 to pivot so that ladder section 2 is substantially parallel to and underneath platform 32. This configuration of the ladder section 2 being collapsed and pivoted underneath platform 32 is shown in FIG. 4, which is further described below.

Pivot connection 44 can be any suitable connection, including a hinge or a portion of flexible material. If pivot connection 44 is a hinge, the hinge can be locked at a desired angle and can include several locking positions at prescribed angles.

The suitable connection provided by pivot connection 44 can span the entire length of mounting portion 10 or only be contained in one or more sections of mounting portion 10.

For transport or storage of the tree stand system 1, both the ladder section 2 and the stand section 3 can be guided into their fully collapsed position, which is shown in FIG. 4, which is a right hand side view of a collapsed tree stand system 1. To place tree stand system 1 in its collapsed position, a user performs the following steps, first the user removes seat strap 38 from around tree 30 and removes ladder strap 15 from around tree 30. The user then disengages the locking mechanisms 6 for each extended rail section 4 so that each rail section 4 slides vertically down into the rail section below it. Then the user disengages hinge 42 of brace 40 if present. Next, supports 36 are folded against platform 32 and seat 3 is folded to be away from platform 32. Lastly, platform 32 is folded along pivot connection 44 so that platform 32 and ladder section 2 are substantially parallel, as shown in FIG. 4. During setup of the tree stand system 1, these steps are performed in reverse. Each of the hinges and pivot connections in the tree stand system can also include a locking mechanism so that their rotation can be stopped if desired.

Ladder strap 15 and seat strap 38 can be removed or can be folded into an empty space provided in the collapsed tree stand system 1. Ladder strap 15 and seat strap 38 can also be arranged so that collapsed tree stand system 1 can be worn on a user's back, utilizing backpack type straps or more easily carried in a user's arms. Also, additional straps can be added so that collapsed tree stand system 1 can be worn on a user's back or more easily carried in a user's arms.

### Example 1

The following example describes one embodiment, and the use thereof, of the present disclosure and refers to the general embodiment illustrated in FIG. 1. FIG. 5 illustrates a partially extended tree stand system 1 that has been set up by a user. In this example, the nearly all components of the tree stand system 1 are composed of aluminum, with the total weight of the tree stand system 1 being about 35 pounds. In this example, the user has walked a distance into a forest and has chosen a suitable tree 30 to set the tree stand system ion. For the walk, the user has carried the tree stand system 1 in its fully collapsed configuration, (as shown in FIG. 4) on his back, similar to a backpack, with ladder strap 15 over one shoulder and seat strap 38 over the other shoulder.

The user begins by pivoting the ladder section 2 away from the stand section 3 about the pivot connection 44. In this example, pivot connection 44 is a metal hinge that spans the distance of the mounting portion 10. Once the ladder section 2 has been pivoted away, the user begins extending each of the plurality of rail sections 4 so that locking mechanism 6 engage and cause the rail section 4 to remain in an extended state. Initially, the user extends all of the plurality of rail sections 4 but realizes that the tree strap 15 will not reach around tree 30, so the user disengages two of the plurality of rail sections (indicated by reference number 13 in FIG. 5) to lower tree strap 15 as shown in FIG. 5. Now that tree strap 15 is at a suitable height, one end is looped around tree 30 and ratcheted tightly to rail section 4. As another example, if ladder strap 15 is mounted on the sixth rail section, and if each rail section is about 1 foot, then ladder strap 15 would be about six feet above the ground if all rail sections are extended, but if the locking mechanisms 6 of the 3^{rd} and 4^{th} rail sections from the ground are disengaged, then ladder strap 15 will be at about four feet from the ground.

After tree strap 15 is secured, the user can climb the ladder section 2 and pivot platform, 32 about pivot connection 44 so that braces 40 support platform 32 and one end of tree strap 38 can be looped around tree 30 and ratcheted tightly to support 36. The user can then adjust seat 34 and sit on it. Ladder strap 15 and tree strap 38 are shown as visible in FIG. 5 even though tree 30 would block their view from the perspective of FIG. 5 under normal operating conditions.

The described embodiments of the present disclosure are intended to be illustrative rather than restrictive, and are not intended to represent every embodiment of the present disclosure. Various modifications and variations can be made without departing from the spirit or scope of the disclosure as set forth in the following claims both literally and in equivalents recognized in law.

What is claimed is:

1. A tree stand system, the system comprising:
a ladder section, wherein the ladder section comprises a plurality of rail sections, wherein each of the plurality of rail sections can be maintained in an extended state by a locking mechanism and wherein the ladder section comprises a ladder strap of adjustable height; and
a stand section, wherein the ladder section and the stand section are pivotally connected and can rotate as compared to each other about the pivotal connection.

2. The tree stand system of claim 1, wherein the tree stand system can be transported on the back of a user in a collapsed position.

3. The tree stand system of claim 1, wherein the stand section further comprises a tree strap.

4. The tree stand system of claim 1, wherein ladder section does not detach from the stand section.

5. The tree stand system of claim 1, wherein a portion of the rail sections of the ladder section are extended.
